(19) United States
(12) Patent Application Publication
(10) Pub. No.: US 2025/0061349 A1
(43) Pub. Date: Feb. 20, 2025

(54) SEMANTIC AND AUDIOVISUAL ANALYSIS TECHNIQUES

(71) Applicant: LAER AI, Inc., New York, NY (US)

(72) Inventors: Igor LABUTOV, New York, NY (US); Bishan YANG, New York, NY (US)

(73) Assignee: LAER AI, Inc., New York, NY (US)

(21) Appl. No.: 18/807,276

(22) Filed: Aug. 16, 2024

Related U.S. Application Data
(60) Provisional application No. 63/520,526, filed on Aug. 18, 2023.

(51) Int. Cl. G06N 5/02; G06N 5/01

(52) U.S. Cl. CPC G06N 5/02; G06N 5/01

(57) ABSTRACT

A system and method for inconsistency detection. A method includes semantically analyzing a first set of data to extract features. The features include subjects represented in the first set of data. Semantically analyzing the first set of data includes applying a machine learning model. The first set of data is consolidated into a knowledge base based on the extracted features. The knowledge base includes a graph having nodes and edges. The nodes represent the subjects, and the edges represent connections among the subjects. The knowledge base is queried based on a second set of data in order to obtain knowledge base query results. Querying the knowledge base includes semantically analyzing the second set of data in order to identify more subjects. Semantically analyzing the second set of data includes applying the machine learning model. Data among the second set of data is validated based on the knowledge base query results.

### CROSS-REFERENCE TO RELATED APPLICATIONS

This application claims the benefit of U.S. Provisional Application No. 63/520,526 filed on Aug. 18, 2023, the contents of which are hereby incorporated by reference.

### TECHNICAL FIELD

The present disclosure relates generally to electronic document analysis, and more specifically to techniques for semantically analyzing electronic documents.

### BACKGROUND

As computer-aided solutions continue to evolve and grow in use, so too does the need for improvements to computing capabilities for these systems. In particular, some artificial intelligence (AI) systems are being developed to aid in performing activities in real-time. Operators of these systems rely on them to provide accurate and timely actions. However, even for AI systems, processing large amounts of data which may contain inconsistencies and which may come in differing forms presents a significant technical challenge. Existing AI solutions have difficulty in evaluating the merits of a statement and identifying inconsistencies, which may cause issues such as effectively summarizing inaccurate information. These inaccuracies may be further compounded by the hallucinogenic effect many existing large language models (LLMs) face, where partial randomization may lead to the AI system introducing further inaccurate statements on top of any inaccuracies in underlying data it has observed during training.

One such area where AI systems may be used to aid operators is in legal tech. In the labyrinthine world of legal proceedings, depositions and trials play a significant tole in proceedings. They serve as platforms where testimonies are rendered, and truths are sought. Yet, the reliance on human memory, coupled with the natural biases and potential for deception, often poses challenges for attorneys aiming to pinpoint inaccuracies or contradictions in statements.

Traditionally, lawyers had to depend heavily on their own prowess, thoroughness in case preparation, and perhaps a paralegal's assistance in real-time to catch discrepancies during a deposition or trial. This approach, although effective to an extent, leaves room for human error and can be significantly impacted by the vastness of information in complex cases.

It would therefore be advantageous to provide solutions for real-time deposition and trial assistance. It would be further advantageous for such solutions to minimize human error and amplify accuracy and reliability.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for inconsistency detection. The method comprises: semantically analyzing a first set of data for a matter in order to extract a plurality of features, wherein the set of features includes a plurality of subjects represented in the first set of data, wherein semantically analyzing the first set of data includes applying a machine learning model; consolidating the first set of data into a knowledge base based on the extracted plurality of features, wherein the knowledge base includes a graph having a plurality of nodes and a plurality of edges, wherein the plurality of nodes represent the plurality of subjects, wherein the plurality of edges represent connections among the plurality of subjects and are between pairs of nodes among the plurality of nodes; querying the knowledge base based on a second set of data in order to obtain knowledge base query results, wherein querying the knowledge base includes semantically analyzing the second set of data in order to identify at least one subject of the plurality of subjects represented in the second set of data, wherein semantically analyzing the second set of data includes applying the machine learning model; and validating at least a portion of the second set of data based on the knowledge base query results.

Certain embodiments disclosed herein also include a non-transitory computer readable medium having stored thereon causing a processing circuitry to execute a process, the process comprising: semantically analyzing a first set of data for a matter in order to extract a plurality of features, wherein the set of features includes a plurality of subjects represented in the first set of data, wherein semantically analyzing the first set of data includes applying a machine learning model; consolidating the first set of data into a knowledge base based on the extracted plurality of features, wherein the knowledge base includes a graph having a plurality of nodes and a plurality of edges, wherein the plurality of nodes represent the plurality of subjects, wherein the plurality of edges represent connections among the plurality of subjects and are between pairs of nodes among the plurality of nodes; querying the knowledge base based on a second set of data in order to obtain knowledge base query results, wherein querying the knowledge base includes semantically analyzing the second set of data in order to identify at least one subject of the plurality of subjects represented in the second set of data, wherein semantically analyzing the second set of data includes applying the machine learning model; and validating at least a portion of the second set of data based on the knowledge base query results.

Certain embodiments disclosed herein also include a system for inconsistency detection. The system comprises: a processing circuitry; and a memory, the memory containing instructions that, when executed by the processing circuitry, configure the system to: semantically analyze a first set of data for a matter in order to extract a plurality of features, wherein the set of features includes a plurality of subjects represented in the first set of data, wherein semantically analyzing the first set of data includes applying a machine learning model; consolidate the first set of data into a knowledge base based on the extracted plurality of features, wherein the knowledge base includes a graph having a plurality of nodes and a plurality of edges, wherein the plurality of nodes represent the plurality of subjects, wherein the plurality of edges represent connections among the plurality of subjects and are between pairs of nodes among the plurality of nodes; query the knowledge base based on a second set of data in order to obtain knowledge base query results, wherein querying the knowledge base includes semantically analyzing the second set of data in order to identify at least one subject of the plurality of subjects represented in the second set of data, wherein semantically analyzing the second set of data includes applying the machine learning model; and validate at least a portion of the second set of data based on the knowledge base query results.

Certain embodiments disclosed herein include a method, non-transitory computer readable medium, or system as noted above or below, wherein the first set of data includes a plurality of portions, further including or being configured to perform the following step or steps: tagging the plurality of portions of the first set of data with a plurality of tags, wherein the plurality of tags correspond to the plurality of subjects represented in the first set of data, wherein the first set of data is consolidated into the knowledge base based further on the plurality of tags.

Certain embodiments disclosed herein include a method, non-transitory computer readable medium, or system as noted above or below, wherein each of the first set of data and the second set of data includes structured data and unstructured data, further including or being configured to perform the following step or steps: creating enriched data based on the plurality of tags, wherein the enriched data includes at least one combination of at least a portion of the structured data and at least a portion of the unstructured data of the first set of data, wherein the at least one combination is created with respect to the plurality of features.

Certain embodiments disclosed herein include a method, non-transitory computer readable medium, or system as noted above or below, wherein the second set of data is captured based on a session, further including or being configured to perform the following step or steps: monitoring audiovisual content of the session in order to determine at least one audiovisual score for the session, wherein each of the at least one audiovisual score indicates a likelihood that a respective aspect of the audiovisual content of the session demonstrates an inconsistency with the second set of data; and determining an inconsistency score for the session based on the at least a portion of the knowledge base query results; and determining a combined validation score based on the at least one audiovisual score and the inconsistency score, wherein the second set of data is validated based further on the combined validation score.

Certain embodiments disclosed herein include a method, non-transitory computer readable medium, or system as noted above or below, further including or being configured to perform the following step or steps: analyzing video of the session in order to identify at least one visual cue, wherein each of the at least one visual cue is a deviation from at least one pattern in movement of an individual in the session.

Certain embodiments disclosed herein include a method, non-transitory computer readable medium, or system as noted above or below, further including or being configured to perform the following step or steps: analyzing audio of the session in order to identify at least one auditory cue, wherein each of the at least one auditory cue is a deviation from at least one pattern in voice production of an individual in the session.

Certain embodiments disclosed herein include a method, non-transitory computer readable medium, or system as noted above or below, wherein the session includes a plurality of questions and a plurality of first responses, further including or being configured to perform the following step or steps: generating a plurality of second responses by applying a language model to the plurality of questions and the first set of data, wherein the plurality of second responses is a plurality of predicted responses to the plurality of questions; and comparing the plurality of first responses to the plurality of second responses, wherein the at least a portion of the second data set is validated based on the comparison between the plurality of first responses and the plurality of second responses.

Certain embodiments disclosed herein include a method, non-transitory computer readable medium, or system as noted above or below, further including or being configured to perform the following step or steps: generating an enriched transcript based on the validation, wherein the enriched transcript includes a plurality of links to a plurality of portions of the first set of data.

Certain embodiments disclosed herein include a method, non-transitory computer readable medium, or system as noted above or below, further including or being configured to perform the following step or steps: outputting at least one recommendation to a teleprompter for display on the teleprompter, wherein the at least one recommendation is determined based on the validation.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe various disclosed embodiments.

FIG. 2 is a flowchart illustrating a method for generating recommendations according to an embodiment.

FIG. 3 is a flowchart illustrating a method for consolidating a knowledge base according to an embodiment.

FIG. 4 is a schematic diagram of a semantic analyzer according to an embodiment.

### DETAILED DESCRIPTION

The various disclosed embodiments include methods and systems for semantic analysis and, in particular, semantic analysis leveraging integrations of structured and unstructured data. Various disclosed embodiments utilize machine learning models including, but not limited to, large language models (LLMs) and other language models, in order to process a combination of structured and unstructured data for semantic analysis.

Various disclosed embodiments provide AI-based techniques for enhancing accuracy and reliability of data in electronic documents (e.g., electronic documents representing information obtained during depositions and trials). Systems in accordance with various disclosed embodiments may be configured for real-time transcription and monitoring such that the systems are configured to actively capture questions and responses in real-time in order to process live exchanges in real-time.

Further, various disclosed embodiments utilize techniques for validating statements (e.g., statements made as answers or other responses to questions) against data stored in a comprehensive database containing various electronic documents related to a given matter (e.g., messages such as emails and texts, files, and the like). Moreover, such disclosed embodiments may include cross-referencing current responses against previous responses, such as previous statements made by the same entity or individual and statements made by other entities or individuals involved in the matter. This cross-referencing may unearth inconsistencies which may represent inaccuracies or promising opportunities to probe for inaccuracies.

Certain disclosed embodiments further utilize audiovisual analysis techniques in tandem with semantic analysis of statements in order to improve detection of potential inaccuracies. Audio and video feeds may be continuously observed and analyzed in coordination with semantic analysis in order to infer additional potential indicators of inaccuracies.

Certain disclosed embodiments also provide real-time annotations on electronic documents such as digital transcripts. These annotations may indicate potentially inaccurate statements represented in such electronic documents, and may further indicate a degree of likelihood of inaccuracy (e.g., ranking based on likelihood of inaccuracy). Moreover, results of semantic analysis may be utilized to enrich the annotations with data from other electronic documents which were cross-referenced as part of semantic analysis. The enrichments may provide sources illustrating the potential inaccuracies or otherwise provide context as to why certain statements contained within an electronic document may warrant further analysis.

Various disclosed embodiments provide an objective approach to making decisions with respect to potential inaccuracies in electronic documents. This approach may allow for identifying potential inconsistencies or other inaccuracies which may warrant further analysis and may be used, for example, to prompt operators to change tact (e.g., by changing a line of questioning, presenting evidence, or otherwise changing the approach to questioning).

Such an approach also provides an alternative to manual evaluation of responses to questions, which is subject to human error and often relies on subjective judgments about whether a response “seems” accurate or otherwise how the questioner “feels” about a subject of questioning or the responses to questions in situations where there is not a direct inconsistency or incompatibility between statements in different electronic documents. The result of such manual questioning is that potentially fruitful avenues of questioning may be lost, forgotten, or otherwise missed. Additionally, failure to ask certain questions at optimal times may result in losing opportunities to successfully pursue certain lines of questioning. The disclosed embodiments may further aid in optimizing lines of questioning in order to discover more potential inconsistencies.

Various disclosed embodiments provide improved architectures and configurations of AI systems which may be utilized to realize and facilitate various disclosed embodiments. The disclosed embodiments may further utilize an interconnected, unified knowledge base.

In addition to the technical advantages described herein, the disclosed embodiments may be utilized in contexts such as legal contexts in order to enhance legal proceedings by offering real-time, accurate, objective, data-driven insights into accuracy of statements, which may aid legal professionals in discerning the truth.

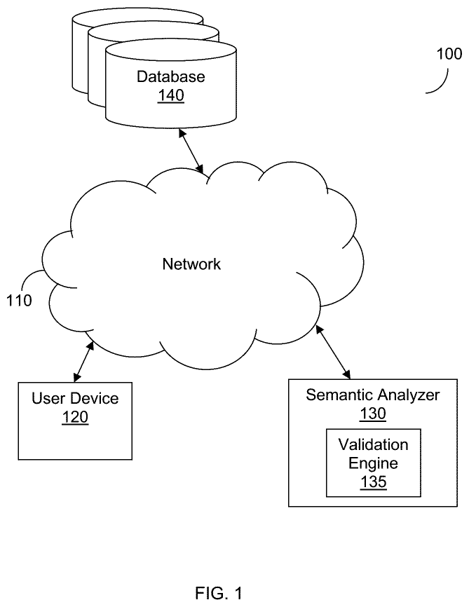

FIG. 1 shows an example network diagram 100 utilized to describe the various disclosed embodiments. In the example network diagram 100, a user device 120, a semantic analyzer 130, and a plurality of databases 140-1 through 140-N (hereinafter referred to individually as a database 140 and collectively as databases 140, merely for simplicity purposes) communicate via a network 110. The network 110 may be, but is not limited to, a wireless, cellular or wired network, a local area network (LAN), a wide area network (WAN), a metro area network (MAN), the Internet, the worldwide web (WWW), similar networks, and any combination thereof.

The user device 120 may be, but is not limited to, a personal computer, a laptop, a tablet computer, a smartphone, a wearable computing device, or any other device capable of receiving and displaying notifications. The user device 120 may receive recommendations or other notifications from the semantic analyzer 130, and may display such recommendations or notifications. As discussed herein, the recommendations or notifications may further include or otherwise be realized as annotated electronic documents such as, but not limited to, annotated digital transcripts, annotated electronic messages, annotated computer files, and the like.

The semantic analyzer 130 is configured to analyze data including electronic documents in order to identify inconsistencies as described herein. More specifically, in accordance with various disclosed embodiments, the semantic analyzer 130 is configured to integrate preconstructed structured data with unstructured data (e.g., raw data) in order to enrich the data being semantically analyzed. Further, in at least some embodiments, the semantic analyzer 130 is configured to integrate accuracy scoring with audio-visual scoring in order to aid in discernment of accuracy or otherwise identify opportunities to explore potential inaccuracies.

In an embodiment, the semantic analyzer 130 includes (as shown) or is communicatively connected to (not shown) a validation engine 135. In an embodiment, the validation engine 135 is configured to integrate and process data from multiple data sources (e.g., data sources among the databases 140). In particular, the data includes electronic documents, and in particular at least includes electronic documents containing textual content which may demonstrate inconsistencies with content in other electronic documents.

In accordance with certain non-limiting example legal use cases, the textual content may include prior testimonies, case documents, external or otherwise public data, user-uploaded data, combinations thereof, and the like.

Prior testimonies may be realized as a systematic catalog of statements provided by individuals with respect to a given matter (e.g., a given case). Such statements may be provided during events such as, but not limited to, depositions, courtroom testimonies, and the like. Inconsistencies between statements made in the same matter may be indicative of inconsistencies between different testimonies, between testimonies and other evidence, and the like.

Case documents may include various forms of data related to a given matter. In accordance with various disclosed embodiments, the case documents may include data both in unstructured form (e.g., emails, text documents, scans of handwriting, etc.) and structured form (e.g., tables, databases, spreadsheets, electronic forms, etc.). Such structured and unstructured data may be integrated and utilized to enrich each other, to enrich other textual content, both, and the like. Moreover, in an embodiment, the structured and unstructured data are indexed in order to allow for efficient cross-referencing with other content.

External or public data may include, but is not limited to, information existing in the public domain such as news articles, press releases, other public records, and the like. Such public data may be utilized for validation as described herein in accordance with various disclosed embodiments. To this end, in some embodiments, the databases 140 may include one or more public databases, and the semantic analyzer 130 is configured to ingest data from such public databases.

User-uploaded data may include any other data provided by one or more users (such as, but not limited to, a user of the user device 120) in order to supplement other data analyzed by the semantic analyzer 130.

In accordance with various disclosed embodiments, the semantic analyzer 130 is configured to consolidate data into a knowledge base organized based on tags used to identify potential semantic relationships between subjects represented therein. As discussed further below, the knowledge base may be realized via one or more graphs including nodes representing such subjects and edges representing potential relationships between those subjects (e.g., relationships indicated by common tags shared between nodes representing the subjects). The semantic analyzer may query the knowledge base, for example, in order to identify potentially relevant data for a given statement to be used for validation of that statement.

The data analyzed by the semantic analyzer 130, including any electronic documents containing such data, may be stored in one or more of the databases 140. Alternatively, such data may be provided by a system such as, but not limited to, the user device 120. As discussed herein, in accordance with various disclosed embodiments, such data may include both structured and unstructured data, where the semantic analyzer 130 is configured to integrate the structured data with the unstructured data in order to produce enriched datasets, which may be utilized to improve analysis as described herein.

It should be noted that FIG. 1 depicts an implementation of various disclosed embodiments, but that at least some disclosed embodiments are not necessarily limited as such. Other deployments, arrangements, combinations, and the like, may be equally utilized without departing from the scope of the disclosure.

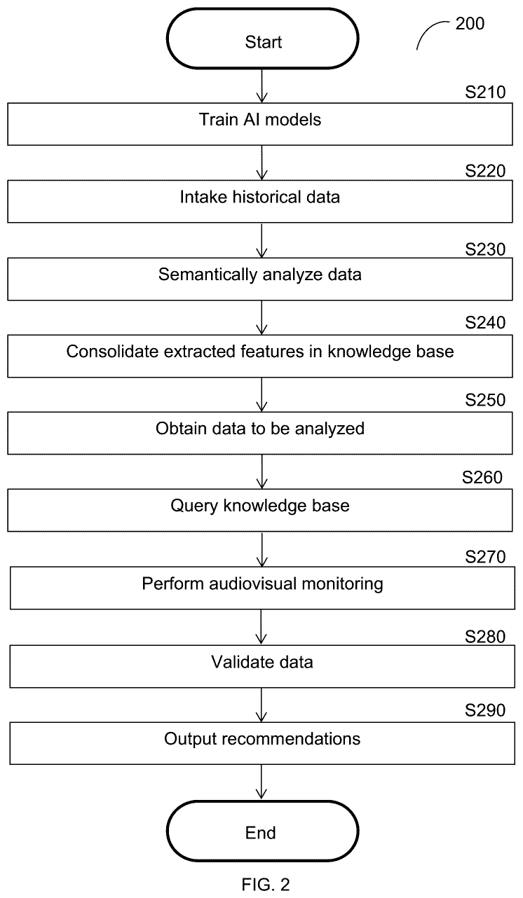

FIG. 2 is a flowchart 200 illustrating a method for generating recommendations according to an embodiment. In an embodiment, the method is performed by the semantic analyzer 130, FIG. 1.

At optional S210, one or more artificial intelligence (AI) models are trained. In an embodiment, the AI models at least include one or more language models such as, but not limited to, machine learning models such as large language models (LLMs). In a further embodiment, a language model may be fine-tuned for a target use case using training data related to the target use case. As a non-limiting example, when the target use case is detecting deceptions during depositions or other legal question-and-answer sessions, a language model may be fine-tuned using training data including transcripts of question-and-answer sessions as well as other electronic documents which represent evidence in a legal matter. More specifically, the language model may be fine-tuned in order to identify potential subjects indicated in textual content such as, but not limited to, entities (e.g., individuals or organizations), events, locations, and the like.

More specifically, in an embodiment, the training data used to train the machine learning models includes a combination of structured and unstructured data. As noted herein, various disclosed embodiments integrate structured and unstructured data. Training the machine learning models based on a combination of structured and unstructured data may further improve accuracy of detecting subjects in content.

In a further embodiment, the AI models include a machine learning model trained based on training visual content, a machine learning model trained based on training audio content, or both. Such training visual content and training audio content may be or may include content from historical question-and-answer sessions, from electronic documents of historical matters, or both. In a further embodiment, the machine learning models may be trained using supervised learning using a labeled training set, for example with labels indicating whether a given response of a responder shown in visual content or speaking in audio content was inconsistent with other electronic documents. Such machine learning models may therefore be trained to detect patterns in auditory and visual cues, which in turn may aid in identifying potential indicators of deceit which may be utilized to more accurately detect potential inconsistencies.

At S220, historical data intake is performed. The historical data intake may include, but is not limited to, ingesting data from a variety of data sources. In particular, in accordance with various disclosed embodiments, the ingested data includes historical data for a given matter which may be related to a subsequent question-and-answer session for the matter. In a further embodiment, the historical data includes electronic documents, and in particular electronic documents including a combination of structured and unstructured data.

At S230, the historical data is semantically analyzed in order to extract one or more sets of features. In an embodiment, semantically analyzing the historical data includes applying the AI models and, in particular, applying one or more language models in order to identify potential subjects indicated in the textual content, potential connections between the subjects indicated in the textual content, both, and the like.

At S240, the extracted features are consolidated in a knowledge base. In an embodiment, nodes may be created for subjects identified within the historical data, and edges may be established between those nodes based on identified connections between subjects indicated in the textual content.

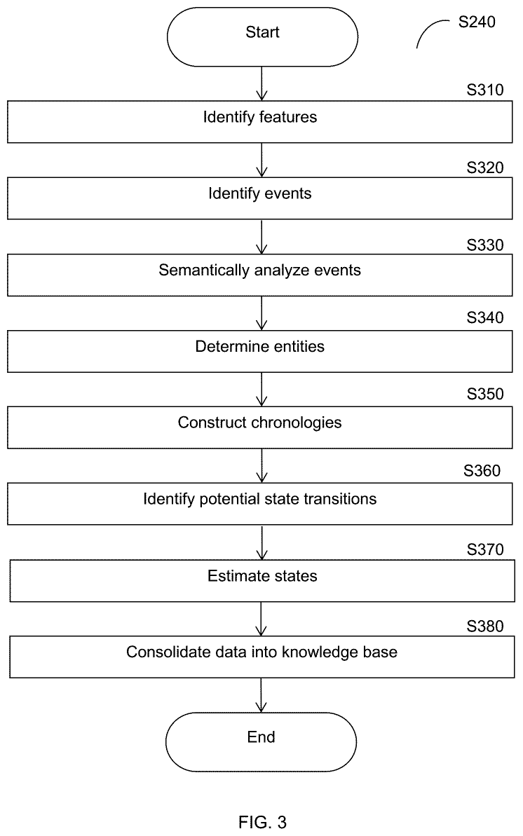

In an embodiment, consolidating the extracted features in the knowledge base includes creating one or more enriched datasets including unstructured and structured data. An example process for consolidating features in a knowledge base including creating one or more enriched datasets is described further below with respect to FIG. 3.

At S250, a set of data to be analyzed is obtained. The set of data may be retrieved (e.g., from one of the databases 140, FIG. 1) or may be received (e.g., from the user device 120, FIG. 1). The set of data may be or may include, but is not limited to, data representing a question-and-answer session, where responses to questions are to be analyzed for potential inconsistencies in order to determine potential avenues for questioning that may warrant further investigation. Such data may be or may include, but is not limited to, audio content, textual content (e.g., text of a transcript), both, and the like. When the content includes audio content, S250 may further include transforming the audio content into textual content, for example using speech-to-text.

At S260, the knowledge base is queried based on the set of data to be analyzed. In an embodiment, the knowledge base may return, based on the query, potentially related subjects (e.g., events, entities, locations etc.), for example, subjects represented by nodes in the knowledge base which are connected via edges to nodes representing subjects indicated in the data to be analyzed. To this end, for each subject indicated in the data to be analyzed, the knowledge base may return one or more potentially related subjects. The potentially related subjects may be returned along with their respective tags which, as discussed further below with respect to FIG. 3, may indicate aspects of the subjects such as, but not limited to, event types, states, chronology tags (e.g., chronological order), times, combinations thereof, and the like. In a further embodiment, the results from the knowledge base may further indicate which portions of data are associated with each potentially related subject. These portions of data may be analyzed in the following steps in order to identify potential inaccuracies, inconsistencies, or other indicators thereof.

At optional S270, audiovisual monitoring is performed with respect to the data to be analyzed. In an embodiment, performing the audiovisual monitoring with respect to the data to be analyzed includes synchronizing times between audiovisual data and language content represented in the data to be analyzed (e.g., language represented in audio content, textual content, etc.). That is, the audiovisual content and language content are synchronized in order to relate times within the audiovisual content to respective times in the language content. As discussed herein, this may be utilized to detect potential inaccuracies (e.g., inaccuracies, determined by comparing statements against facts represented in other electronic documents of documents such as evidence, prior testimony, or public data) or otherwise to detect avenues of potential questioning which may warrant pursuing.

In an embodiment, the audiovisual monitoring further includes determining one or more audiovisual scores. Each audiovisual score may represent a likelihood that the audio and video of a given interaction exhibits indicators of potential deception (i.e., indicators which might increase the likelihood that the interaction demonstrates an inconsistency with other electronic documents and facts contained therein). To this end, in such an embodiment, S270 further includes applying one or more machine learning models trained based on training audio content, training video content, or both, as discussed above, in order to learn patterns which may be indicative of inconsistencies. The outputs of such models may include audiovisual scores or may be utilized to determine the audiovisual scores.

In an embodiment, the audiovisual monitoring integrates computer vision, auditory signal processing, and machine learning to detect and assess non-verbal cues presented by an individual during questioning. Through systematic analysis of these cues, attributes related to the individual's cognitive state, veracity, or extent of information can be inferred.

In an embodiment, the audiovisual monitoring includes video analysis. Such video analysis may be performed in order to identify potential visual cues which may be indicative (either by themselves or in combination with other indicators) of potential inconsistencies or subjects warranting further discussion such as, but not limited to, micro-gestures, pupil dilation, posture shifts, blink rate, gaze patterns, combinations thereof, and the like. Micro-gestures may include swift, sometimes subconscious, facial movements such as, but not limited to, eye twitches, lip tightening, slight frowns, and the like. Pupil dilation include changes in pupil size which may be indicative of heightened cognitive load or emotional arousal, which may be indicative of a falsehood. Posture shifts, and in particular sudden or repeated shifts in posture, may indicate discomfort or unease, which may accompany false or inaccurate information. Higher than average blink rate may be an indicator of stress or discomfort, while lower than average blink rate may be an indicator of a heightened focus, both of which might accompany a potential fabrication. Unusual gaze patterns (such as, but not limited to, avoiding eye contact or a prolonged fixed gaze) may be associated with deceit or unease, while darting eyes may indicate internal conflict or nervousness.

In an embodiment, the audiovisual monitoring includes audio analysis. Such audio analysis may be performed in order to identify potential auditory cues which may be indicative (either by themselves or in combination with other indicators) of potential inconsistencies or subjects warranting further discussion such as, but not limited to, vocal tone, backchannel signals, pauses, throat clearing, speech rate, stress indicators, combinations thereof, and the like. Vocal tone changes such as sudden elevations or drops in pitch may be indicative of emotional reactions or potential inconsistencies. Backchannel signals may include sounds or words which may be used as placeholders in conversation (e.g., “uh-huh”, “mhm”, “right”, etc.) and may therefore reveal gaps in content, particularly when an increase in backchannel signals is detected. Repeated throat clearing with increased frequency may be a sign of nervousness or hesitation (and, therefore, potentially inaccurate statements). Changes in speech rate such as rapid acceleration may indicate nervousness, while sudden deceleration may suggest that words are being carefully chosen to avoid certain topics. Stress indicators may include stress tremors or inconsistencies in voice, which may be indicative of potential nervousness or deceit (and, therefore, increase the likelihood of inconsistencies).

In this regard, it is noted that these visual and auditory cues are often manually evaluated by a person asking the questions in a manner that is holistic and requires subjective judgments both on whether a visual cue is being presented at all and whether the visual cue is indicative of a potential falsehood (i.e., which suggests that there may be an inconsistency). These techniques are prone to human error and produce inconsistent results which vary between human questioners. By using machine learning to analyze for specific visual and auditory cues, these cues, as well as their potential for unearthing inconsistencies, may be evaluated in an objective, consistent manner as compared to manual observation. In particular, when these cues are combined with contextual information from a knowledge base created as described herein, a sufficiently contextualized analysis may be performed without relying on manual human observations and judgments.

It is further noted that artificial intelligence (AI) has demonstrated particular effectiveness at learning and analyzing data for patterns such that AI is particularly suited to audiovisual analysis. Accordingly, using AI techniques for audiovisual analysis in combination with semantic analysis further improves the ability of an automated system to determine potential inconsistencies or sources thereof. Further, it is recognized that AI may allow for quickly recognizing such patterns and detecting deviations in such patterns, which may improve the ability of the system to operate in real-time. That is, AI may be able to more accurately establish baseline behavior patterns for particular individuals being questioned very quickly, which in turn may allow for more efficiently detecting deviations from these baselines as contrasted with manual observation (which often requires much more information and experience for the questioner).

Moreover, it is noted that audiovisual analysis alone may sometimes fail to properly contextualize auditory and visual cues. That is, an AI system may properly detect deviations from patterns, but these deviations from patterns do not, by themselves, necessarily demonstrate deceit which would lead to falsehoods. For example, a subject of questioning may be nervous because of circumstances or may have unusual voice production because of sickness or becoming dry over an extended session. By using semantic analysis, and in particular semantic analysis with respect to strengths of connections represented in the knowledge graph, in combination with audiovisual analysis, audiovisual analysis may be utilized to filter potential inconsistencies or sources of inconsistencies detected via the knowledge graph in order to reduce false positive inconsistency or other follow up detections.

At S280, the data to be analyzed is validated. In an embodiment, validating the data includes analyzing the data with respect to query results from the knowledge base in order to identify potential inconsistencies, inaccuracies, or otherwise to identify indicators thereof. Results of the validation may include any such inconsistencies, inaccuracies, or indicators thereof, or an indication that a given statement represented in the data is not inconsistent with data in other electronic documents. That is, the validation may be utilized to detect when data from other electronic documents may refute statements represented in the data to be analyzed, or otherwise to detect potential sources of inconsistencies which could refute statements represented in the data to be analyzed. In other words, the validation may yield either a validation of a given statement (i.e., consistent with other facts represented in data) or refutation of a given statement (i.e., inconsistent or potentially inconsistent with other facts represented in data). In a further embodiment, validating the data may further include searching through electronic documents directly (e.g., electronic documents representing matter files, prior testimonies, etc.).

In some embodiments, performing the validation further includes synthesizing raw data (e.g., data which is not represented in the knowledge base or otherwise is unprocessed). The raw data synthesis may be, but is not limited to, performed in parallel with querying the knowledge base. The raw data may be analyzed in combination with the knowledge base results, for example by semantically analyzing the raw data using machine learning models to identify subjects represented in the knowledge base. Such raw data synthesis may therefore be used, for example, in order to provide additional context to content in the knowledge base. As a non-limiting example, inputs provided by a user involved in the case may be analyzed with respect to subjects in the knowledge base in order to unearth additional potential connections.

In a further embodiment, performing the validation for a given statement made in response to a question further includes generating a predicted response to the question. To this end, in such an embodiment, performing the validation includes querying a model such as a language model (e.g., a LLM) using a query indicating the question. Such a query may further include or refer to data represented in the knowledge base to be utilized by the language model in order to generate a predicted response to the question. In yet a further embodiment, the query may further include or refer to only data represented in the knowledge base which might be related to the question. To this end, in such an embodiment, results returned from the knowledge base for subjects represented in the question, and in particular portions of data represented in the knowledge base associated with nodes connected to nodes representing subjects indicated in the question, are input to the language model in order to generate the predicted response. By using only potentially relevant data (as determined based on connections between subjects represented in the knowledge base), the amount of data to be input to and analyzed by the language model may be reduced, thereby reducing use of computing resources. Additionally, limiting the data to be analyzed to only relevant data may improve accuracy of results of the language model by avoiding having the language model analyze data which may be superficially similar (e.g., structured similarly) but which are not actually related with respect to underlying content.

That is, in an embodiment, the language model is queried based on the question and data represented in the knowledge base in order to generate an expected or otherwise predicted response to the question based on information represented in the knowledge base. In a further embodiment, the predicted response may be compared to an actual response to the question (e.g., a response spoken by a deponent) in order to determine whether the predicted response is inconsistent with the actual response, and the statement may be validated based further on the consistency or inconsistency between the predicted response and the actual response.

The validation process may be or may include performing direct validation, indirect validation, or both. To this end, performing the validation may include querying a language model using a question and response as well as data represented by the results from the knowledge base. Moreover, such a query may include a predetermined direct validation portion, one or more predetermined indirect validation portions, both, and the like. In a further embodiment, performing the validation includes generating an inconsistency score representing an inconsistency between a statement and data in electronic documents. Such an inconsistency score may be generated based on results of direct validation, indirect validation, or both, and may indicate a likelihood that any potential inconsistencies detected during direct validation and indirect validation demonstrate inconsistencies with other data.

Direct validation may include, but is not limited to, explicit inconsistencies. That is, a direct validation includes checking whether any statements directly contradict any other statements. The direct validation check may be based on pairs of diametric key words or phrases, based on negative words or phrases (e.g., “no” or “not”), or otherwise based on incompatibilities between statements. To this end, performing direct validation may include, but is not limited to, submitting, to a language model, a query including a predetermined direct validation portion “Do any statements in the following data directly contradict the response to this question?” As a non-limiting example, a statement “I never emailed Mr. Smith about the project” may result in a validation output of “[Inconsistency Detected: Email from Respondent to Mr. Smith dated Jan. 23, 2024 with subject ‘Regarding the Project’.].”

Implicit validation may include, but is not limited to, identifying potentially conflicting or otherwise potentially inconsistent information. Such information may not directly contradict statements included in responses to questions in a binary “yes/no” manner, but may indicate facts which might be incompatible with a statement. To this end, performing indirect validation may include submitting, to a language model, a query including a predetermined indirect validation portion “Do any facts in evidence suggest a potential timing inconsistency with the following response to a question?” As a non-limiting example, a statement “I was out of the country during the entire month of April” may result in a validation output of “[Potential Inconsistency: Bank statement shows credit card transaction at ‘Local Bistro, City X’ on April 15th. Additionally, phone records show local city cell tower pings from April 10th to April 20th.].”

In yet a further embodiment, when audiovisual monitoring is performed in order to generate audiovisual scores for one or more interactions (e.g., interactions including questions and corresponding responses), performing the validation further includes generating a combined validation score for each interaction based on the audiovisual score for that interaction and the validation score for the response in the interaction. As noted above, combining factual inconsistencies based on connections in a knowledge graph with audiovisual cues allows for further improving accuracy of detecting such inconsistencies.

At S290, one or more recommendations are output. The recommendations may be or may include, but are not limited to, recommendations to follow up on one or more statements represented in the electronic documents. The recommendations may further indicate potentially inconsistent electronic documents and, more specifically, which portions of those electronic documents represent potential inconsistencies (e.g., certain portions of text, audio, visual content, etc.). In some embodiments, the recommendations may include recommendations to ask one or more follow up questions (e.g., follow up questions generated by applying a language model to text of portions of data related to a detected inconsistency).

The recommendations may be determined based on the inconsistency scores, the combined validation scores, or both. Moreover, each recommendation may be with respect to a particular interaction. As a non-limiting example, a recommendation may be generated for each interaction which has an inconsistency score or a combined validation score above a predetermined threshold, where each such recommendation is a recommendation to follow up on the respective interaction.

In an embodiment, any or all of the recommendations may be realized via a teleprompter. To this end, in an embodiment, outputting the recommendations includes communicating the recommendations to a teleprompter for display on the teleprompter. This may allow the individual asking questions to maintain eye contact or otherwise to avoid averting their gaze.

In some embodiments, the recommendations may be or may include an enriched transcript or other enriched content. Such enriched content may include textual or other content from a given question-and-answer session including interactions having questions and corresponding responses. More specifically, the enriched content may include details about the recommendations such as, but not limited to, visually or otherwise distinguished portions of the content indicating where potential inconsistencies or other areas for follow up were detected using validation as discussed above. The fed transcript may be or may include annotations, and may therefore be realized as an annotated transcript.

In a further embodiment, the enriched transcript may be further enriched with links or other references to content, for example, with links to potentially inconsistent content. As a non-limiting example, when a statement is “I never sent an email to John in August 2024,” a link to an email from the speaker to John dated August 2024 may be included in the enriched transcript. Such links or other references may allow users viewing the enriched transcript to delve deeper into potential inconsistencies.

Moreover, in some embodiments, a user may engage with the system providing the recommendations (e.g., by providing inputs to be processed at least by a language model) in order to obtain additional information such as, but not limited to, further data related to subjects involved in a given line of questioning. This may allow the user to query the system for potentially relevant information or ask for clarification about a potential inconsistency, which may allow them to better prepare follow up questions.

In an embodiment, the recommendations are output in real-time during a question-and-answer session (e.g., during a deposition). In a further embodiment, the recommendations may further include one or more expected responses for comparison to actual questions during the question-and-answer session. Moreover, data such as audiovisual scores may be output in real-time and overlaid on top of textual content (e.g., text of a deposition being created using speech-to-text based on audio captured during the deposition). Such real-time overlay feedback may aid a user in adjusting questioning as the session proceeds. The textual content to be overlaid may be captured in real-time using text-to-speech, or may be streamed from transcriber outputs (e.g., from a stream of text being typed by a court reporter). In some embodiments, alerts including recommendations may be generated and sent to a user device (e.g., the user device 120, FIG. 1) in real-time after a given interaction (e.g., within a predetermined period of time after a response to a question is completed) when a combined validation score or an inconsistency score for the interaction is above a predetermined threshold.

In some embodiments, the recommendations may be based on potential avenues for inconsistent information. That is, the recommendations may be based on inconsistencies which have already been detected, or based on statements which might warrant further questioning in order to yield additional statements which contain inconsistencies. By analyzing semantic layers of statements, topics which are ripe for further exploration may be identified. Such topics may be identified directly (e.g., based on subjects which are light on connections as represented in the knowledge graph or which are connected to recurring subjects which are particularly relevant to a given matter as determined based on frequency of introduction and therefore may warrant further exploration) or implicitly (e.g., based on brief or indirect acknowledgment of a given subject rather than a detailed explanation).

Direct topic identification may include, but is not limited to, checking the subjects mentioned in a statement to subjects represented by nodes in the knowledge graph Implicit topic identification may include, but is not limited to, querying a language model using respective predetermined portions of queries which request the language model to identify any subjects which may have been only briefly or indirectly mentioned.

FIG. 3 is a flowchart S240 illustrating a method for consolidating features in a knowledge base according to an embodiment.

At S310, features extracted from data to be consolidated in the knowledge base are identified. In an embodiment, the features are extracted as described above with respect to S230. As noted above, in an embodiment, the features at least include potential subjects identified within historical content for a matter.

At S320, events are identified based on the extracted features. In an embodiment, identifying the events includes applying one or more event identification rules. Such event identification rules may establish rules for distinguishing events identifying as subjects within text from other types of subjects (e.g., entities, locations, etc.).

In an embodiment, identifying the events further includes identifying a type of each event. The type of each event may be among a set of predetermined potential event types. In a further embodiment, portions of data representing each event are tagged with event type. To this end, in an embodiment, the event identification rules further define characteristics of different types of events used to determine event type for events identified in textual content. For legal use cases, non-limiting examples of event types may include, but are not limited to, hirings, deal closures, negotiations, and the like.

At S330, portions of data representing the identified events are semantically analyzed in order to identify other potential subjects related to each event. In an embodiment, S330 includes applying one or more language models fine-tuned to identify potential connections between subjects represented in textual content.

At S340, entities involved in each of the events are determined. In an embodiment, instances of the determined entities represented in the data are tagged to indicate that they are entities, which entity they represent, both, and the like. In an embodiment, subjects connected to the events identified within the historical data are analyzed in order to determine whether each subject is an entity. To this end, in a further embodiment, one or more entity identification rules. Such entity identification rules may establish rules for distinguishing entity identifying as subjects within text from other types of subjects (e.g., entities, locations, etc.).

At S350, one or more chronologies are constructed for the identified events. In an embodiment, the chronologies are constructed at least based on timestamps or other indicators of time associated with respective portions of the data to be analyzed. In a further embodiment, the chronologies are constructed based further on contents of the respective portions of data including, but not limited to, textual content, metadata, both, and the like. Such textual content and metadata may indicate dates and times (e.g., a date and time mentioned at the beginning of a deposition), may indicate relative times for the portions of data (e.g., text indicating a prior deposition may be indicative that the text represents a situation which occurred after that deposition), both, and the like.

In an embodiment, portions of the data are tagged with respect to the constructed chronologies. That is, a sequence of each chronology may be represented with respective tags, for example, tags representing an ordered sequence of events. As a non-limiting example, a sequence of events in a chronology including 5 events may include a first event tagged with a “1st in sequence” tag, a second event tagged with a “2nd in sequence” tag, and the like.

At S360, potential state transitions are identified among the events. In an embodiment, identifying the potential state transitions includes deciphering transitions from one event to another within textual content. The state transitions may be deciphered using a set of state transition identification rules which may define transitions between states based on factors such as, but not limited to, locations within data, semantic analysis of temporal relationships between events, formats of data in structured datasets, keywords indicative of state transitions, combinations thereof, and the like.

At S370, one or more states represented in the data are estimated. Each state is a condition with respect to one or more elements relevant to a given matter which may depend on the use case, and has a respective period of time during which the state existed. To this end, in an embodiment, each state is a condition having a start time, and may further have an end time (e.g., a definitive end time or a non-definitive end time such as for an ongoing state).

In an embodiment, estimating the states includes applying one or more machine learning models trained using data representing historical states with respect to historical data in order to parse potential indicators (e.g., explicit indicators, implicit indicators, or both) of states such as, but not limited to, indicators representing potential causal links between events. In an embodiment, portions of the data are tagged with their respective states (i.e., the state estimated for that portion of data). In a further embodiment, one or more predetermined state-defining rules may be applied in order to determine the states. Such state-defining rules may define, for example but not limited to, known lengths of times for certain types of states such that estimated states belonging to a certain type are initially determined to exist for their respective lengths of time. Such rules may be utilized in coordination with other indicators of length of time of a given state in order to determine how long a given state lasted.

The states may be or may include, but are not limited to, a knowledge state (e.g., a state defining when certain facts were known to certain individuals or organizations), a physical state (e.g., health, physical location, etc.), emotional state, role state (e.g., a state indicating a role that a person plays within an organization or team), responsibility state (e.g., a state indicating one or more responsibilities with respect to a given event such as which actions were taken or caused by certain entities), ownership state (e.g., a state indicating an ownership of an asset or stake at a given point in time). States may overlap, that is, different states may occupy the same period of time or overlap in time periods. As a non-limiting example, a knowledge state may include all time after Mar. 3, 2023, while a physical state includes all times between Jan. 1, 2023, and Jun. 6, 2023. To this end, in an embodiment, the state-defining rules may further define which types of states can coexist and which types of states cannot coexist. As a non-limiting example, a person occupying a first physical state at a first location cannot coexist with the same person occupying a second physical state at a different second location such that the first and second physical states cannot coexist. In such an example, the first physical state may be determined to have an end time before a start time of the second physical state.

At S380, the data is consolidated into a unified knowledge base. In an embodiment, the knowledge base is realized as or otherwise includes one or more graphs, with each graph including a set of nodes and edges connecting between nodes. The nodes may represent subjects or potential subjects identified via semantic analysis as discussed above, the edges may represent connections between those subjects indicated in textual data.

The knowledge base may include, but is not limited to, an integrated structure of subjects such as, but not limited to, events, entities (e.g., individuals, organizations, etc.), locations, and the like. In an embodiment, such subjects are represented via respective nodes which may be interlinked (e.g., as represented by edges between the nodes), thereby allowing for determining inferences based on the connections represented within the knowledge base. To this end, in a further embodiment, the knowledge base includes nodes and edges connecting between nodes, where the nodes represent potentially related subjects and the edges represent relationships between the subjects.

In some embodiments, the edges may further be assigned weights representing strengths of relationships between subjects (e.g., weights determined based on tags, combinations of tags, and the like). To this end, in such an embodiment, weight determination rules are applied based on the tags. The weight determination rules may be or may include predetermined rules that assign weights based on types of tags, numbers of tags shared between portions of data representing the subjects, both, and the like.

In an embodiment, consolidating the data includes enriching portions of the data with other portions of the data. In particular, in a further embodiment, enriched data is created such that the enriched data includes a combination of structured data and related unstructured data, where the structured and unstructured data contextualize each other. In yet a further embodiment, the structured and unstructured data are combined based on the tags. More specifically, nodes in the graph connected by edges based on the tags may be identified as related to each other, and respective portions of data for such nodes may be combined during enrichment.

As a result, the structured and unstructured data used to create a given enriched dataset are structured and unstructured data which are semantically related, chronologically related, and the like. That is, portions of structured and unstructured data which are tagged using the same tags or related tags (e.g., tags indicating that they relate to the same entity or entities, that they are chronologically related, that they are from the same state, etc.). Chronologically related portions of data may be or may include, but are not limited to, data from the same or around the same time (e.g., within a predetermined threshold time of each other), data representing events in sequence, both, and the like.

By tagging portions of the data and consolidating those portions based on the tags, disparate portions of data which are represented in different formats may be accurately used to enrich each other. The tags may be used to objectively connect certain nodes to each other, as well as to objectively determining degrees of connections (e.g., using weight determination rules defined with respect to predetermined types of tags, numbers of tags, both, etc.).

Once the consolidated knowledge base has been created, the knowledge base may be queried with respect to subsequent data to be analyzed as described herein (e.g., as discussed above with respect to S260). More specifically, the data to be analyzed may be scanned for potential subjects, and the knowledge base may be queried for nodes representing those subjects in order to identify potential connections with other portions of data (e.g., other portions of data representing or otherwise related to the same subjects). Further, the results of querying the knowledge base may be utilized to identify related events, states, chronological relationships, or other contextual information related to the content of the query (e.g., a statement or other information represented in the query).

Various non-limiting examples which illustrate semantic analysis of questions and corresponding responses follow.

As a first non-limiting example demonstrating a consistency check with respect to previous statements represented in electronic documents, a question and corresponding answer may be as follows:
Question: “Ms. Turner, in your earlier deposition, you mentioned that you were at the Park View Cafe on the evening of March 5th. Is that correct?”
Answer: “No, I was at my home that evening.”

A non-limiting example output by a system in accordance with one or more disclosed embodiments, the output may be or may include “[Inconsistency Detected: Reference Deposition Date XX/XX/XXXX—‘I was at the Park View Cafe on the evening of March 5th.’]” Such an output may indicate an inconsistency between a first electronic document containing a deposition transcript from a first deposition and a second electronic document containing a deposition transcript from a second deposition.

As a second non-limiting example demonstrating a validation against evidence with respect to previous communications represented in electronic documents, a question and corresponding answer may be as follows:
Question: “Mr. Johnson, did you email Mr. Smith about the financial irregularities you noticed on January 15th?”
Answer: “I've never sent such an email.”

A non-limiting example output by a system in accordance with one or more disclosed embodiments, the output may be or may include “[Inconsistency Detected: Email from Mr. Johnson to Mr. Smith dated January 15th with subject ‘Financial Irregularities Observed’. Content Preview: ‘Smith, I've noticed some financial discrepancies in the Q4 reports . . . ’]” Such an output may indicate an inconsistency between a first electronic document containing an email communication and a second electronic document containing a deposition transcript from a deposition.

As a third non-limiting example demonstrating an audiovisual inconsistency detection with respect to language content and audiovisual content from a session involving a subject, a question and corresponding answer may be as follows:
Question: “Did you sign the contract knowing the clauses mentioned in section 4?”
Answer: “I didn't read section 4.”

A non-limiting example output by a system in accordance with one or more disclosed embodiments, the output may be or may include “[Potential Deception Detected: Elevated voice pitch during the phrase ‘didn't read’. Facial analysis: Brief avoidance of eye contact.]” Such an output may indicate an inconsistency between a first electronic document containing audiovisual content from a deposition and a second electronic document containing a deposition transcript from the deposition.

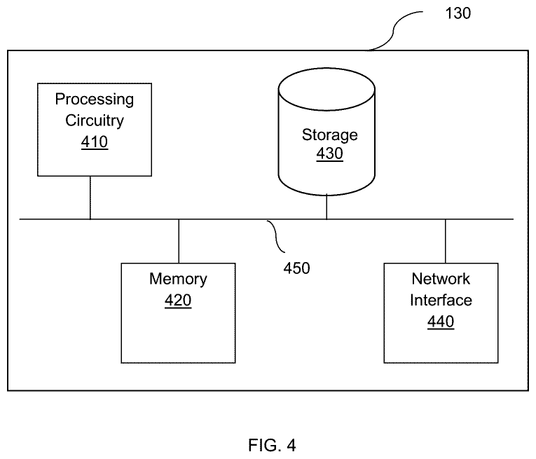

FIG. 4 is an example schematic diagram of a semantic analyzer 130 according to an embodiment. The semantic analyzer 130 includes a processing circuitry 410 coupled to a memory 420, a storage 430, and a network interface 440. In an embodiment, the components of the semantic analyzer 130 may be communicatively connected via a bus 450.

The processing circuitry 410 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

The memory 420 may be volatile (e.g., random access memory, etc.), non-volatile (e.g., read only memory, flash memory, etc.), or a combination thereof.

In one configuration, software for implementing one or more embodiments disclosed herein may be stored in the storage 430. In another configuration, the memory 420 is configured to store such software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 410, cause the processing circuitry 410 to perform the various processes described herein.

The storage 430 may be magnetic storage, optical storage, and the like, and may be realized, for example, as flash memory or other memory technology, compact disk-read only memory (CD-ROM), Digital Versatile Disks (DVDs), or any other medium which can be used to store the desired information.

The network interface 440 allows the semantic analyzer 130 to communicate with other systems, devices, components, applications, or other hardware or software components, for example as described herein.

It should be understood that the embodiments described herein are not limited to the specific architecture illustrated in FIG. 4, and other architectures may be equally used without departing from the scope of the disclosed embodiments.

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various embodiments disclosed herein can be implemented as hardware, firmware, software, or any combination thereof. Moreover, the software may be implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A method for inconsistency detection, comprising:
semantically analyzing a first set of data for a matter in order to extract a plurality of features, wherein the plurality of features includes a plurality of subjects represented in the first set of data, wherein semantically analyzing the first set of data includes applying a machine learning model;
consolidating the first set of data into a knowledge base based on the extracted plurality of features, wherein the knowledge base includes a graph having a plurality of nodes and a plurality of edges, wherein the plurality of nodes represent the plurality of subjects, wherein the plurality of edges represent connections among the plurality of subjects and are between pairs of nodes among the plurality of nodes;
querying the knowledge base based on a second set of data in order to obtain knowledge base query results, wherein querying the knowledge base includes semantically analyzing the second set of data in order to identify at least one subject of the plurality of subjects represented in the second set of data, wherein semantically analyzing the second set of data includes applying the machine learning model; and
validating at least a portion of the second set of data based on the knowledge base query results.

2. The method of claim 1, wherein the first set of data includes a plurality of portions, further comprising:
tagging the plurality of portions of the first set of data with a plurality of tags, wherein the plurality of tags correspond to the plurality of subjects represented in the first set of data, wherein the first set of data is consolidated into the knowledge base based further on the plurality of tags.

3. The method of claim 2, wherein each of the first set of data and the second set of data includes structured data and unstructured data, wherein consolidating the extracted plurality of features into the knowledge base further comprises:
creating enriched data based on the plurality of tags, wherein the enriched data includes at least one combination of at least a portion of the structured data and at least a portion of the unstructured data of the first set of data, wherein the at least one combination is created with respect to the plurality of features.

4. The method of claim 1, wherein the second set of data is captured based on a session, further comprising:
monitoring audiovisual content of the session in order to determine at least one audiovisual score for the session, wherein each of the at least one audiovisual score indicates a likelihood that a respective aspect of the audiovisual content of the session demonstrates an inconsistency with the second set of data; and
determining an inconsistency score for the session based on the at least a portion of the knowledge base query results; and
determining a combined validation score based on the at least one audiovisual score and the inconsistency score, wherein the second set of data is validated based further on the combined validation score.

5. The method of claim 4, wherein monitoring the audiovisual content further comprises:
analyzing video of the session in order to identify at least one visual cue, wherein each of the at least one visual cue is a deviation from at least one pattern in movement of an individual in the session.

6. The method of claim 4, wherein monitoring the audiovisual content further comprises:
analyzing audio of the session in order to identify at least one auditory cue, wherein each of the at least one auditory cue is a deviation from at least one pattern in voice production of an individual in the session.

7. The method of claim 4, wherein the session includes a plurality of questions and a plurality of first responses, further comprising:
generating a plurality of second responses by applying a language model to the plurality of questions and the first set of data, wherein the plurality of second responses is a plurality of predicted responses to the plurality of questions; and
comparing the plurality of first responses to the plurality of second responses, wherein the at least a portion of the second data set is validated based on the comparison between the plurality of first responses and the plurality of second responses.

8. The method of claim 1, further comprising:
generating an enriched transcript based on the validation, wherein the enriched transcript includes a plurality of links to a plurality of portions of the first set of data.

9. The method of claim 1, further comprising:
outputting at least one recommendation to a teleprompter for display on the teleprompter, wherein the at least one recommendation is determined based on the validation.

10. A non-transitory computer readable medium having stored thereon instructions for causing a processing circuitry to execute a process, the process comprising:
semantically analyzing a first set of data for a matter in order to extract a plurality of features, wherein the plurality of features includes a plurality of subjects represented in the first set of data, wherein semantically analyzing the first set of data includes applying a machine learning model;
consolidating the first set of data into a knowledge base based on the extracted plurality of features, wherein the knowledge base includes a graph having a plurality of nodes and a plurality of edges, wherein the plurality of nodes represent the plurality of subjects, wherein the plurality of edges represent connections among the plurality of subjects and are between pairs of nodes among the plurality of nodes;
querying the knowledge base based on a second set of data in order to obtain knowledge base query results, wherein querying the knowledge base includes semantically analyzing the second set of data in order to identify at least one subject of the plurality of subjects represented in the second set of data, wherein semantically analyzing the second set of data includes applying the machine learning model; and
validating at least a portion of the second set of data based on the knowledge base query results.

11. A system for inconsistency detection, comprising:
a processing circuitry; and
a memory, the memory containing instructions that, when executed by the processing circuitry, configure the system to:
semantically analyze a first set of data for a matter in order to extract a plurality of features, wherein the plurality of features includes a plurality of subjects represented in the first set of data, wherein semantically analyzing the first set of data includes applying a machine learning model;
consolidate the first set of data into a knowledge base based on the extracted plurality of features, wherein the knowledge base includes a graph having a plurality of nodes and a plurality of edges, wherein the plurality of nodes represent the plurality of subjects, wherein the plurality of edges represent connections among the plurality of subjects and are between pairs of nodes among the plurality of nodes;
query the knowledge base based on a second set of data in order to obtain knowledge base query results, wherein querying the knowledge base includes semantically analyzing the second set of data in order to identify at least one subject of the plurality of subjects represented in the second set of data, wherein semantically analyzing the second set of data includes applying the machine learning model; and
validate at least a portion of the second set of data based on the knowledge base query results.

12. The system of claim 11, wherein the first set of data includes a plurality of portions, wherein the system is further configured to:
tag the plurality of portions of the first set of data with a plurality of tags, wherein the plurality of tags correspond to the plurality of subjects represented in the first set of data, wherein the first set of data is consolidated into the knowledge base based further on the plurality of tags.

13. The system of claim 12, wherein each of the first set of data and the second set of data includes structured data and unstructured data, wherein the system is further configured to:
create enriched data based on the plurality of tags, wherein the enriched data includes at least one combination of at least a portion of the structured data and at least a portion of the unstructured data of the first set of data, wherein the at least one combination is created with respect to the plurality of features.

14. The system of claim 11, wherein the second set of data is captured based on a session, wherein the system is further configured to:
monitor audiovisual content of the session in order to determine at least one audiovisual score for the session, wherein each of the at least one audiovisual score indicates a likelihood that a respective aspect of the audiovisual content of the session demonstrates an inconsistency with the second set of data; and
determine an inconsistency score for the session based on the at least a portion of the knowledge base query results; and
determine a combined validation score based on the at least one audiovisual score and the inconsistency score, wherein the second set of data is validated based further on the combined validation score.

15. The system of claim 14, wherein the system is further configured to:
analyze video of the session in order to identify at least one visual cue, wherein each of the at least one visual cue is a deviation from at least one pattern in movement of an individual in the session.

16. The system of claim 14, wherein the system is further configured to:
analyze audio of the session in order to identify at least one auditory cue, wherein each of the at least one auditory cue is a deviation from at least one pattern in voice production of an individual in the session.

17. The system of claim 14, wherein the session includes a plurality of questions and a plurality of first responses, wherein the system is further configured to:
generate a plurality of second responses by applying a language model to the plurality of questions and the first set of data, wherein the plurality of second responses is a plurality of predicted responses to the plurality of questions; and
compare the plurality of first responses to the plurality of second responses, wherein the at least a portion of the second data set is validated based on the comparison between the plurality of first responses and the plurality of second responses.

18. The system of claim 11, wherein the system is further configured to:
generate an enriched transcript based on the validation, wherein the enriched transcript includes a plurality of links to a plurality of portions of the first set of data.

19. The system of claim 11, wherein the system is further configured to:
output at least one recommendation to a teleprompter for display on the teleprompter, wherein the at least one recommendation is determined based on the validation.
